(19) United States
(12) Patent Application Publication
(10) Pub. No.: US 2005/0068273 A1
(43) Pub. Date: Mar. 31, 2005

(54) Drive device and drive method of a self light emitting display panel

(75) Inventor: Naoto Suzuki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/911,536

(22) Filed: Aug. 5, 2004

(30) Foreign Application Priority Data
Sep. 30, 2003 (JP) 2003-339019

(51) Int. Cl. G09G 3/30

(52) U.S. Cl. 345/77

(57) ABSTRACT

The present invention is to provide a drive device and a drive method of a self light emitting display panel in which a reverse bias voltage can be effectively applied to light emitting elements without decreasing the lighting time rate. An electrode which applies an electrical potential to cathodes of EL elements 14 is electrically divided into a plurality of blocks along a scan line, it is possible to select a lighting mode in which a forward voltage is applied to the EL elements 14 via lighting drive transistors 12 and a reverse bias voltage applying mode in which a reverse bias voltage is applied to the light emitting elements, and the reverse bias voltage is applied to the EL elements 14 in units of the block in the reverse bias voltage applying mode.

### BACKGROUND OF THE INVENTION

1. Field of the Invention

The present invention relates to a drive device of a display panel in which an light emitting element constituting a pixel is actively driven for example by TFTs, and particularly to a drive device and a drive method of a self light emitting display panel in which a reverse bias voltage can be effectively applied to the light emitting elements.

2. Description of the Related Art

A display employing a display panel constructed by arranging light emitting elements in a matrix pattern has been developed widely. As the light emitting element employed in such a display panel, an organic EL (electroluminescent) element in which for example an organic material is employed in a light emitting layer has attracted attention.

As a display panel employing such organic EL elements, there is an active matrix type display panel in which active elements constituted for example by TFTs (thin film transistors) are added to respective EL elements arranged in a matrix pattern. This active matrix type display panel has properties such as those by which low power consumption can be realized and by which cross talk between pixels is small, and the like, and is particularly suitable for a high definition display constituting a large screen.

FIG. 1 shows one example of a circuit configuration corresponding to one pixel 10 in a conventional active matrix type display panel. In FIG. 1, gate G of a TFT 11 that is a control transistor is connected to a scan line (scan line A1), and source S thereof is connected to a data line (data line B1) Drain D of this control TFT 11 is connected to gate G of a TFT 12 that is a drive transistor and to one terminal of a charges-holding capacitor 13.

Drain D of the drive TFT 12 is connected to the other terminal of the capacitor 13 and to a common anode 16 formed in the panel. Source S of the drive TFT 12 is connected to the anode of an organic EL element 14, and the cathode of this organic EL element 14 is connected to a common cathode 17 for example constituting a reference potential point (ground) formed in the panel.

FIG. 2 schematically shows a state in which the circuit configuration having each pixel shown in FIG. 1 is arranged in a display panel 20, and the respective pixels 10 of the circuit configurations shown in FIG. 1 are formed at respective intersecting positions between respective scan lines Al to An and respective data lines B1 to Bm. In the above-described structure, respective drains D of the drive TFTs 12 are connected to the common anode 16 shown in FIG. 2, and the cathodes of the respective EL elements 14 are connected to the common cathode 17 similarly shown in FIG. 2. In this circuit, when light emission control is performed, a positive power supply terminal of a voltage source El is connected to the common anode 16 formed in the display panel 20 via a switch 18, and a negative power supply terminal of the voltage source E1 is connected to the common cathode 17.

In this state, when an ON voltage is supplied to gate G of the control TFT 11 in FIG. 1 via a scan line, the TFT 11 allows current corresponding to a voltage supplied from the data line to source S to flow from source S to drain D. Thus, during a period in which gate G of the TFT 11 is the ON voltage, the capacitor 13 is charged, and the voltage thereof is supplied to gate G of the drive TFT 12. Current based on the gate voltage and the drain voltage of the TFT 12 flows from source S through the EL element 14 into the common cathode 17 so that the EL element 14 emits light.

When gate G of the TFT 11 becomes an OFF voltage, the TFT 11 becomes a so-called cutoff, and drain D of the TFT 11 becomes in an open state. However, the voltage of gate G of the drive TFT 12 is maintained by electrical charges accumulated in the capacitor 13, and drive current is maintained until a next scan so that light emission of the EL element 14 is maintained. Since a gate input capacitance exists in the drive TFT 12, even when the capacitor 13 is not particularly provided, an operation similar to the above can be performed.

It is known that the organic EL element electrically has a light emission element having a diode characteristic and a static capacitance (parasitic capacitance) connected in parallel thereto and that the organic EL element emits light at an intensity approximately proportional to the forward current of this diode characteristic. With respect to the EL element, it is empirically known that the lifetime of the EL element can be prolonged by one after another applying of a reverse voltage (reversebias voltage) which does not participate light emission.

For example, Japanese Patent Application Laid-Open No. 2001-117534 (page 3, the right column, line 10 through page 5, the right column, line 39, and FIGS. 8 and 11) discloses that the reverse bias voltage is applied between the common anode 16 and common cathode 17. That is, a voltage source E2 shown in FIG. 2 is utilized when the reverse bias voltage is applied, and the switch 18 is switched to the voltage source E2 side when the reverse bias voltage is applied. Thus, the positive power source terminal of the voltage source E2 and the negative power source terminal of the voltage source E2 are connected to the common cathode 17 and the common anode 16, respectively. Accordingly, the reverse bias voltage is applied to the EL element 14 shown in FIG. 1 via source S and drain D of the drive TFT 12.

The drive device disclosed in Japanese Patent Application Laid-Open No. 2001-117534 (page 3, the right column, line 10 through page 5, the right column, line 39, and FIGS. 8 and 11) shows an example in which a time division gradation expression method is utilized and in which the reverse bias voltage is applied to the EL elements. In the time division gradation expression method disclosed in this Japanese Patent Application Laid-Open No. 2001-117534 (page 3, the right column, line 10 through page 5, the right column, line 39, and FIGS. 8 and 11), for example, one frame period is divided into a plurality of subframe periods (which are referred to as subfield periods in Japanese Patent Application Laid-Open No. 2001-117534 (page 3, the right column, line 10 through page 5, the right column, line 39, and FIGS. 8 and 11)), and halftone display is performed by utilizing the total of subframe periods in which organic EL elements have emitted light during one frame period. Meanwhile, since the drive device disclosed in Japanese Patent Application Laid-Open No. 2001-117534 (page 3, the right column, line 10 through page 5, the right column, line 39, and FIGS. 8 and 11) is constructed in such a manner that the EL element 14 is connected between the common anode 16 and the common cathode 17 via the drive TFT 12, in order to apply the reverse bias voltage to the EL element, a period in which all EL elements 14 arranged on the display panel are not illuminated simultaneously has to be set. In this example, control is performed in such a manner that the non-lighting time of the EL elements is set at a completion time of an address period at which a scan signal has finished being sent to all scan lines and that at this time the reverse voltage is applied simultaneously to the all EL elements.

In the drive device disclosed in Japanese Patent Application Laid-Open No. 2001-117534 (page 3, the right column, line 10 through page 5, the right column, line 39, and FIGS. 8 and 11), since the non-lighting time for applying the reverse bias voltage to the EL elements is set other than setting of lighting time and non-lighting time of the EL elements for performing gradation expression, it is unavoidable to decrease a light emission duty ratio of the EL elements, that is, a lighting time rate thereof. As a result, since a substantial light emission intensity of the EL element decreases, in order to compensate this, necessity to increase drive current of the time the EL element emits light occurs, and there is a problem that the load of the power supply circuit increases.

Further, with the example disclosed in Japanese Patent Application Laid-Open No.2001-117534 (page 3, the right column, line 10 through page 5, the right column, line 39, and FIGS. 8 and 11), a problem that the reverse bias voltage has to be applied to the EL element via the impedance between drain D and source S of the drive TFT at the applying time of the reverse bias voltage remains. In this case, it is set that the drive TFT is constant current driven in order to ensure a stable drive operation of the EL element, and therefore the impedance between drain D and source S is high. Thus, even when the reverse bias voltage is applied between the common anode and the common cathode, electrical charges accumulated in the parasitic capacitance of the EL element during a positive bias time cannot be released instantly due to the existence of the drive TFT having a high impedance, and as a result a problem that the reverse bias voltage cannot be applied effectively to the EL element remains.

### SUMMARY OF THE INVENTION

The present invention has been developed as attention to the above-described technical problems has been paid, and it is an object of the present invention to provide a drive device and a drive method of a self light emitting display panel in which the reverse bias voltage can be effectively applied to the EL element without decreasing the lighting time rate.

A drive device of a self light emitting display panel according to the present invention which has been developed in order to solve the problem is a drive device of an active matrix type display panel comprising a plurality of light emitting elements which are arranged at intersecting positions between a plurality of data lines and a plurality of scan lines and whose light emissions are controlled via at least lighting drive transistors, respectively, characterized in that an electrode which applies an electrical potential to cathodes of the light emitting elements is electrically divided into a plurality of blocks along a scan line to be arranged, that it is possible to select a lighting mode in which a forward voltage is applied to the light emitting elements via the lighting drive transistors and a reverse bias voltage applying mode in which a reverse bias voltage is applied to the light emitting elements, and that reverse bias voltage applying means which applies the reverse bias voltage to the light emitting elements in block units operates in the reverse bias voltage applying mode.

A drive method of a self light emitting display panel according to the present invention which has been developed in order to solve the problem is a drive method of an active matrix type display panel comprising a plurality of light emitting elements which are arranged at intersecting positions between a plurality of data lines and a plurality of scan lines and whose light emissions are controlled via at least lighting drive transistors, respectively, characterized in that an electrode which applies an electrical potential to cathodes of the light emitting elements is electrically divided into a plurality of blocks along a scan line to be arranged, that it is possible to select a lighting mode in which a forward voltage is applied to the light emitting elements via the lighting drive transistors and a reverse bias voltage applying mode in which a reverse bias voltage is applied to the light emitting elements, and that in the reverse bias voltage applying mode, the reverse bias voltage is applied to the light emitting elements in block units.

### BRIEF DESCRIPTION OF THE DRAWINGS

FIG. 1 is a view showing an example of a circuit configuration corresponding to one pixel in a conventional active matrix type display panel;

FIG. 2 is view schematically showing a state in which the circuit configurations having respective pixels shown in FIG. 1 are arranged in a display panel;

FIG. 3 is a block diagram showing one embodiment according to a drive method of the present invention;

FIG. 4 is a view showing one example of a circuit configuration of one pixel among pixels respectively arranged in a matrix pattern in a display panel of FIG. 3;

FIG. 5 is a view showing a specific structure in a case where respective pixels are light emission driven;

FIG. 6 is a view showing a relationship between subframe periods within one frame period and lighting and extinguishing periods of light emitting elements;

FIG. 7 is a view schematically showing, corresponding to scan timings, a form in which image data of one frame period is scanned; and

FIG. 8 is views schematically, respectively showing scan images on a display screen, corresponding to scan timings.

### DESCRIPTION OF THE PREFERRED EMBODIMENTS

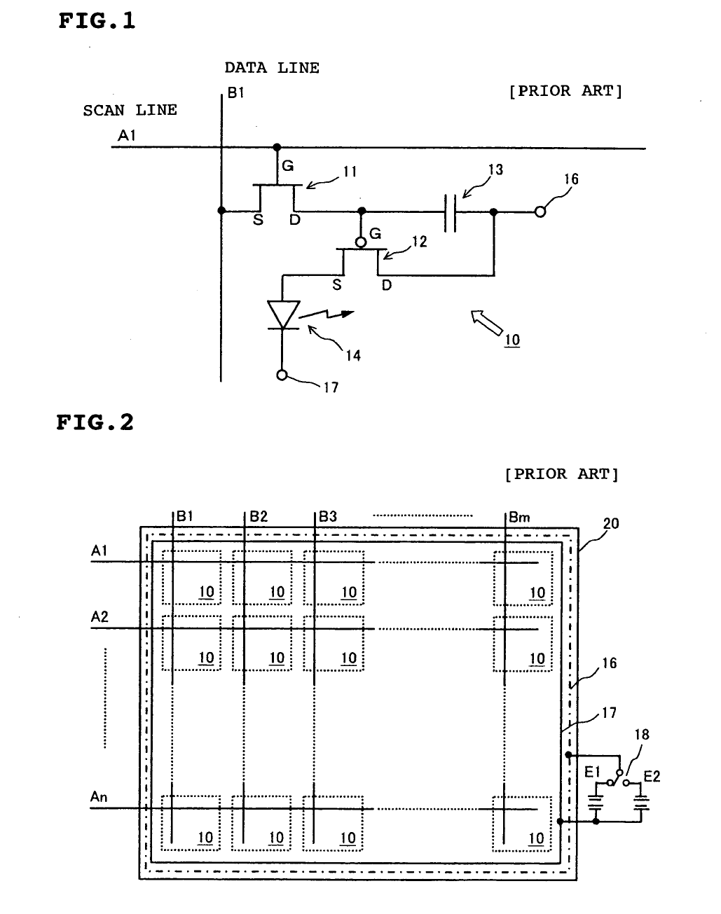

A drive device and a drive method of a self light emitting display panel according to the present invention will be described below with reference to an embodiment shown in the drawings. In the description below, parts corresponding to the respective parts shown in FIGS. 1 and 2 already described are designated by the same reference characters and numerals, and therefore description of individual functions and operations will be omitted suitably.

The conventional example shown in FIGS. 1 and 2 shows an example of a so-called monochrome light emitting display panel in which series circuits of the drive TFTs 12 and EL elements 14 constituting pixels are all connected between the common anode 16 and the common cathode 17. However, a drive device and a drive method of a self light emitting display panel according to the present invention described below not only can be suitably adopted in a monochrome light emitting display panel, of course, but rather can be adopted in a color display panel provided with respective light emitting pixels (subpixels) of R (red), G (green), and B (blue).

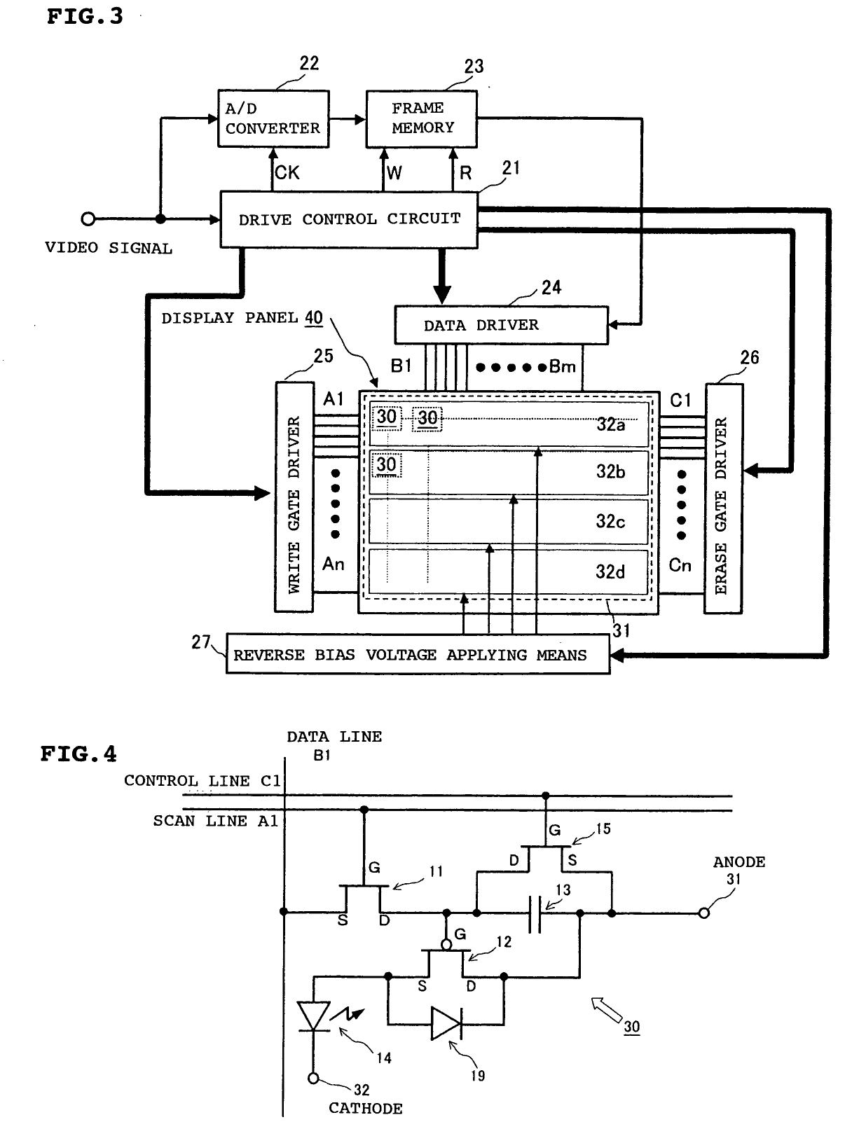

FIG. 3 shows, by means of a block diagram, one embodiment of a drive device and a drive method according to the present invention. In FIG. 3, a drive control circuit 21 controls operations of a data driver 24, a write gate driver 25, an erase gate driver 26, and pixels 30 respectively arranged in a matrix pattern.

First, an inputted analog video signal is supplied to the drive control circuit 21 and an analog/digital (A/D) converter 22. The drive control circuit 21 generates a clock signal CL for the A/D converter 22 and a write signal W and a read signal R for a frame memory 23, based on horizontal and vertical synchronization signals in an analog video signal.

The A/D converter 22 samples the inputted analog video signal based on the clock signal CK supplied from the drive control circuit 21 and converts this into corresponding pixel data for each pixel to supply the data to the frame memory 23. The frame memory 23 operates to sequentially write respective pixel data supplied from the A/D converter 22 in the frame memory 23 by the write signal W supplied from the drive control circuit 21.

When writing of data of one screen (n rows, m columns) part in a self light emitting display panel 40 is completed through such a write operation, the memory 23 supplies drive pixel data which is read out for each line part from first line to nth line to the data driver 24 by the read signal R supplied from the drive control circuit 21.

Meanwhile, at the same time as this, a timing signal is transmitted from the drive control circuit 21 to the write gate driver 25, and based on this signal, the gate driver 25 sequentially sends a gate-on voltage to the respective scan lines as described later. Therefore, as described above, the drive pixel data for each line part which is read out of the memory 23 is addressed for each line by scanning of the gate driver 25. This embodiment is constructed in such a manner that a control signal is transmitted from the drive control circuit 21 to the erase gate driver 26.

The erase gate driver 26 receives the control signal from the drive control circuit 21 and selectively applies a predetermined voltage level to electrode lines (referred to as control lines C1 to Cn in this embodiment) which are obtained by electrical splitting for each scan line and which are arranged as described later to control ON/OFF operation of a later-described erase TFT 15.

As shown in FIG. 3, a cathode 32 is constructed so as to be equally divided into four blocks (respectively referred to as cathode blocks 32a, 32b, 32c, 32d) in an image scan direction on the display panel 40 and to be electrically split and arranged. These cathode blocks are respectively connected to reverse bias voltage applying means 27, and a control signal from the drive control circuit 21 is supplied to this reverse bias voltage applying means 27. This reverse bias voltage applying means 27, receiving the control signal, controls a voltage level which is supplied to the respective cathode blocks. Thus, whether a voltage of the forward direction is applied to the EL elements connected to the respective cathode blocks or a reverse bias voltage is applied thereto is controlled.

FIG. 4 is a view showing one example of a circuit configuration of one pixel among pixels 30 respectively arranged in a matrix pattern in the self light emitting display panel 40. The circuit configuration corresponding to one pixel 30 shown in this FIG. 4 is applied to an active matrix type display panel. This circuit is constructed by adding a TFT 15 that is an erase transistor erasing electrical charges accumulated in a capacitor 13 to the circuit configuration of the pixel 10 shown in FIG. 1 and by further adding a diode 19 connected between source S and drain D of the lighting drive TFT 12 so as to bypass this TFT.

The erase TFT 15 is connected in parallel to the capacitor 13 and can discharge electrical charges of the capacitor 13 instantly by performing an ON operation in accordance with the control signal supplied from the drive control circuit 21 during the time when an organic EL element 14 is performing a lighting operation. Thus, an pixel can be extinguished until a next addressing time.

Meanwhile, the anode of the diode 19 is connected to the anode of the EL element 14, and the cathode of the diode 19 is connected to an anode 31. Accordingly,the diode 19 is connected in parallel between source S and drain D of the drive TFT 12 so as to be in a reverse direction with respect to the forward direction of the EL element 14 having a diode characteristic.

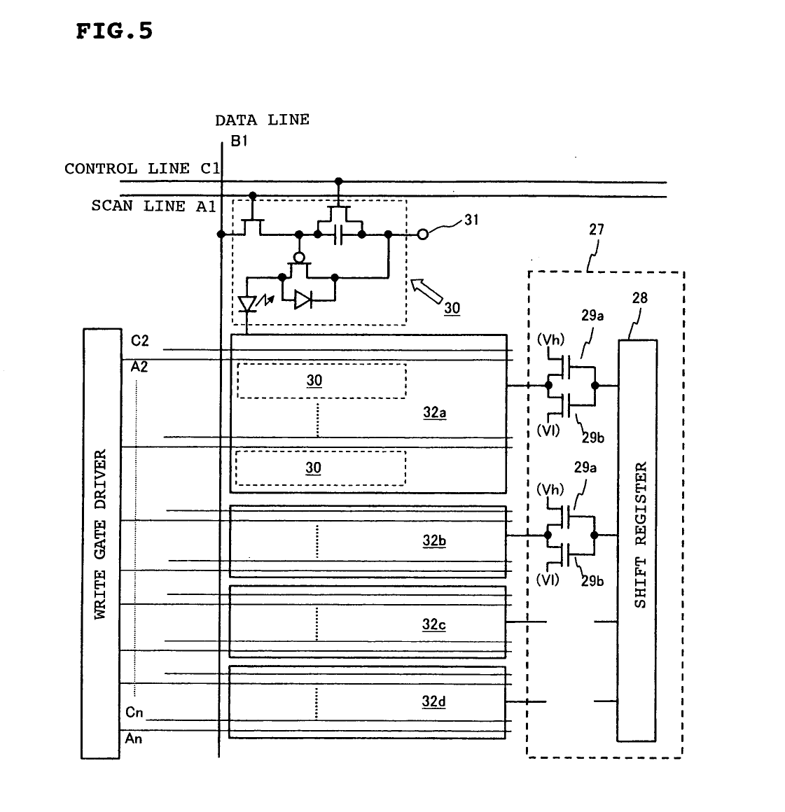

In the circuit configuration shown in FIG. 4, the cathode of the EL element 14 is connected to either one of the cathode blocks 32a to 32d formed corresponding to scan blocks obtained by equally dividing scan lines A1 to An into four groups. Thus, a voltage of a predetermined level is applied to the respective cathode blocks 32a to 32d by the reverse bias voltage applying means 27. That is, here, where a voltage level applied to the common anode 31 is “Va”, “Vh” or “Vl” is selectively applied to the respective cathode blocks 32a to 32d as shown in FIG. 5. A level difference of “Vl” with respect to the “Va”, that is, Va to Vl, is set so as to be a forward direction (for example, approximately 10 volts in the EL element 14, and therefore in a case where the respective cathode blocks 32a to 32d are selectively set to “Vl”, the EL element 14 constituting each pixel 30 becomes in a light emittable state (lighting mode).

The level difference of “Vh” with respect to the “Va”, that is, Va to Vh, is set so as to become the reverse bias voltage (e.g., about −8 volts) in the EL element 14. Therefore, in a case where “Vh” is selectively applied to the respective cathode blocks 32a to 32d, the EL elements 14 constituting the respective pixels 30 are brought to a non-light-emitting state, and at this time the diode 19 shown in FIG. 4 is brought to a “on” state by the reverse bias voltage (a reverse bias voltage applying mode).

As shown in FIG. 5, an applying operation of “Vh” or “Vl” to the respective cathode blocks 32a to 32d is controlled by a shift register 28 disposed in the reverse bias voltage applying means 27. That is, to the shift register 28, supplied from the drive control circuit 21 shown in FIG. 3 is a shift timing signal, as well as a data signal of one subframe part. The shift register 28 sequentially shift-ups the data signal by the shift timing signal so that the data signal is stored. By the data signal of this time stored in each register, either an FET (field effect transistor) or TFTs 29a, 29b are selectively brought to an ON state so that an voltage level of either “Vh” or “Vl” is applied to the cathode blocks 32a to 32d.

Meanwhile, in the above-described circuit configuration, since a supplying time (lighting time) of drive current given to the EL element that is a light emitting element can be changed, a substantial light emission intensity of the organic EL element 14 can be controlled. In this circuit configuration, the above-mentioned time division gradation expression method is employed as a gradation expression method. Specifically, a subframe period having an extinguishing period of the EL element is provided, and weighting is performed treating one or a plurality of subframe periods as a group. Gradation expression is performed treating such a group as a lighting control unit (hereinafter referred to as a weighting subframe method for convenience).

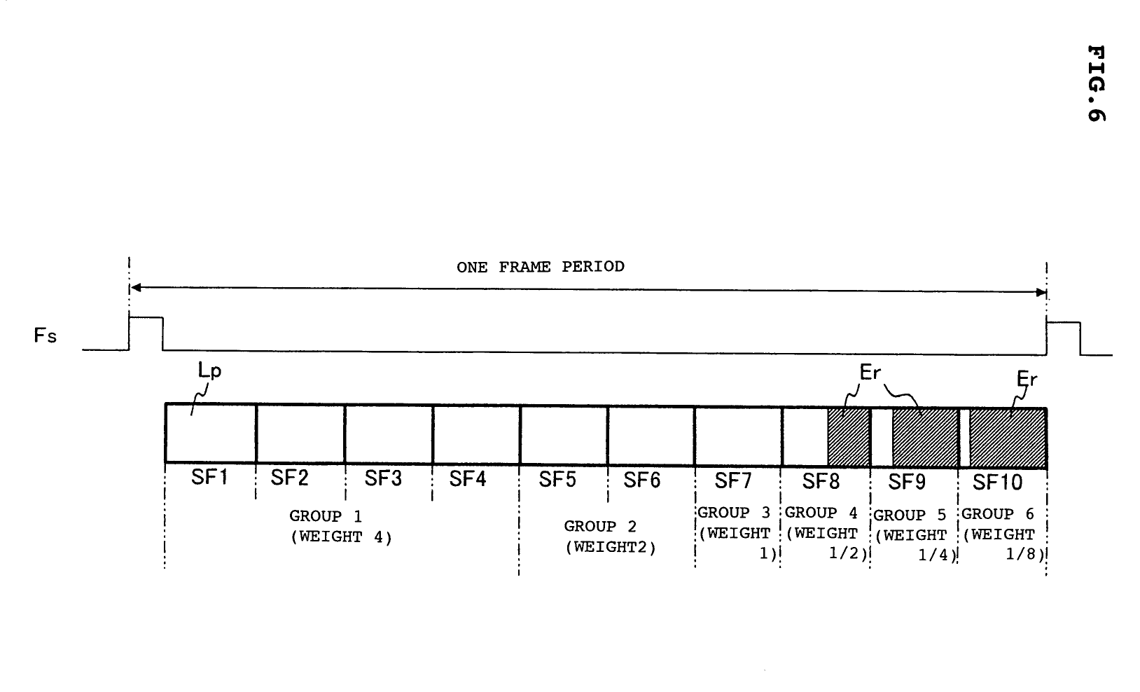

For example, FIG. 6 shows a case where one frame period that is a unit frame period is divided into groups composed of one or a plurality of subframe periods as the weighting subframe method and where respective groups are weighted to perform 64 gradation expression. That is, in one example shown in FIG. 6, groups (shown by Group 1 through Group 6) are treated as units so that lighting control therefor is performed and gradation expression is performed. The respective groups are weighted to lengths of 4:2:1:1/2:1/4:1/8 as time ratios of element lighting times, and expression of 64 gradations is performed by 6-bit (Group 1 through Group 6) expression.

In the groups in which the time ratios are shown by fractions, an extinguishing period Er for the EL elements is provided during the subframe period so that a lighting time within the subframe period is controlled. That is, the erase TFT 15 is turned on in accordance with the control signal from the drive control circuit 21 during a period in which the EL element 14 emits light within each subframe period, and electrical charges of the capacitor 13 is discharged during the extinguishing period Er, so that lighting time control for this organic EL element 14 is realized. In this manner, gradation expression in the circuit configuration of the present embodiment is realized by gradation display means composed of the drive control circuit 21, the data driver 24, the write gate driver 25, and the respective pixels 30.

In this circuit configuration, corresponding to the form that the cathode 32 is equally divided into four blocks, an extinguishing period Er which is ¼ or longer with respect to the subframe period is included in at least one subframe period. That is, for each cathode block, a period in which the all EL elements connected to the respective cathode blocks are extinguished by the extinguishing period Er (hereinafter referred to as all elements extinguishing period for convenience) must always be generated. A drive device and a drive method according to the present invention are characterized in that the all elements extinguishing period is provided for each cathode block and that during this period the reverse bias voltage is applied to the EL elements.

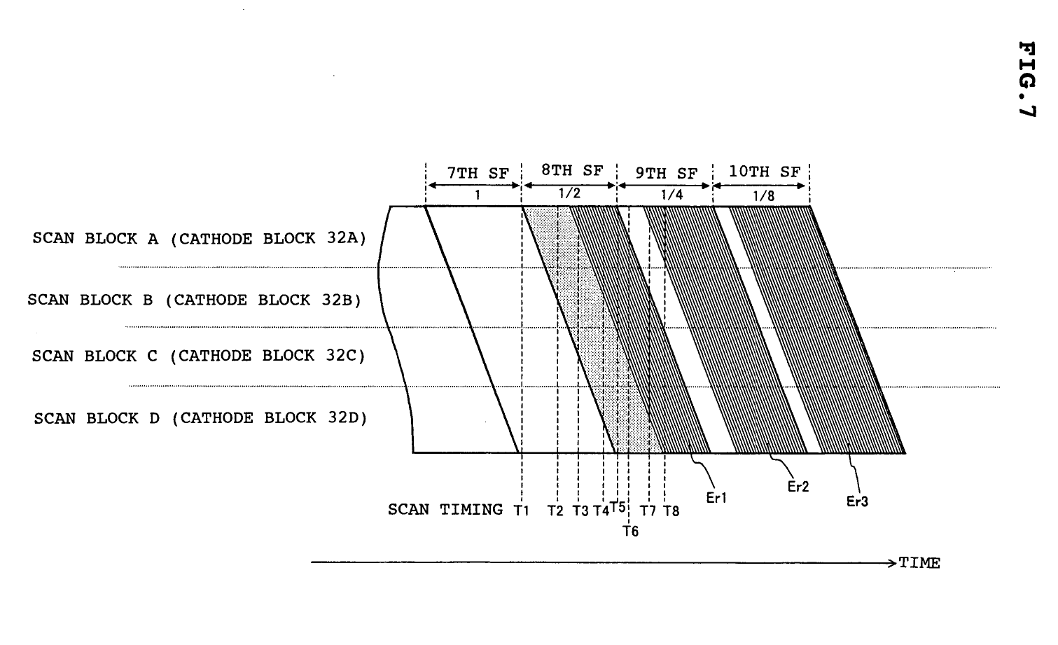

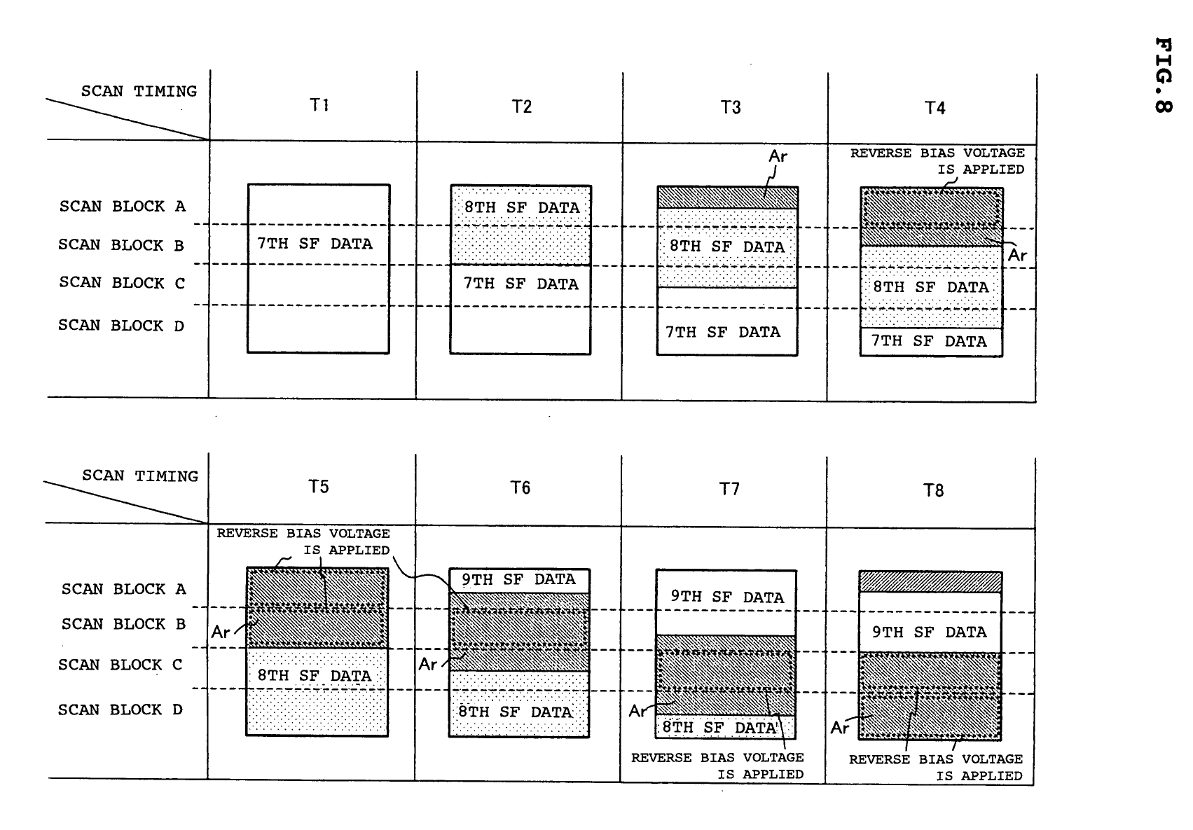

Next, operations in the present circuit configuration in which the reverse bias voltage is applied to the organic EL elements 14 during one frame period will be explained with reference to FIGS. 7 and 8. FIG. 7 is a view schematically showing a form in which scanning is performed by the gate driver 25 in order to display image data of one frame period shown in FIG. 6, corresponding to scan timings T1 to T8. FIG. 8 is a view schematically showing scan images on the display screen, corresponding to the scan timings T1 to T8, respectively. The scan timings T1 to T8 show timings during a period in which data of 8th subframe whose weight is ½ (half of the subframe period is the extinguishing period) is scanned. In the drawings, blocks scanning the EL elements 14 connected to the respective cathode blocks 32a to 32d are shown as scan blocks A to D, respectively.

When the data of 8th subframe in which ½ of the subframe period is the extinguishing period is scanned, an extinguishing operation for the EL elements 14 for forming the extinguishing period is performed sequentially while timing is shifted along the scan direction. Thus, an area Ar of EL elements existing in the extinguishing period Er1 shown ranging the scan timings T3 to T8 of FIG. 8 moves from scan block A to scan block D.

Since the extinguishing period Er1 is ½ period of the subframe period, that is, a period of a part in which two scan blocks are scanned, the all elements extinguishing period can be provided sequentially in the respective scan blocks A to D. Accordingly, as shown in the scan images in the scan timings T4-T8 of FIG. 8, the all elements extinguishing period is respectively generated in the scan blocks A to D, and the reverse bias voltage is applied in a state in which all EL elements 14 in the respective scan blocks are in the extinguishing period (the scan block shown by the broken line). That is, the reverse bias voltage applying means 27 applies the voltage level of “Vh” to the cathode block corresponding to the scan block in the all elements extinguishing period, whereby the reverse bias voltage is applied to all EL elements 14 in its block. In this manner, the reverse bias voltage is applied to the all EL elements 14 constituting one screen during one frame period.

The reverse bias voltage applying means 27 operates to apply the forward voltage to EL elements of a scan block to which the reverse bias voltage is being applied, before scanning of image data of a next subframe is begun. By such an operation, the reverse bias voltage is applied to all EL elements in a scan block in question only during the all elements extinguishing period, and data display of the next subframe can be certainly performed without causing problems. When the reverse bias voltage is applied, since the diode 15 through which the reverse bias voltage is applied to the EL element, bypassing the lighting drive transistor, is provided, the reverse bias voltage can be applied to the EL element effectively.

Thus, in the embodiment according to the present invention, by adopting a configuration in which a cathode obtained by commonly connecting the cathode side of an EL element arranged corresponding to a scan line is divided into four blocks in the scan direction on the display panel 40 to be electrically separated and arranged, together with the time gradation control as described above, the reverse bias voltage can be applied to EL elements at the same time as the extinguishing operation by the time gradation control. In this manner, the reverse bias voltage can be applied to EL elements without sacrificing the light emission duty ratio of the EL elements, that is, the lighting time rate thereof.

Although the cathode 32 is equally divided into four blocks to be arranged in the configuration of one embodiment described above, the present invention is not limited to this, and any configuration may be made as far as the number of divided parts of the cathode 32 corresponds to the length of the extinguishing period of EL elements in one frame period. That is, where the number of divided cathode blocks is N, the extinguishing period may be at least 1/N of a subframe period or greater during the subframe period having the extinguishing period of EL elements.

Although the above-described form has a configuration in which one frame image data is displayed during one frame period, a configuration in which one frame image data is displayed, using a plurality of frame periods, may be employed. Although 64 gradations is used for exemplifying a gradation number, such a gradation number is not limited to this, and a drive device and a drive method according to the present invention can be employed in another gradation number expression. Further, the number of subframes obtained by dividing one frame period shown in the above-described form is merely one example, a drive device and a drive method according to the present invention can be applied without limiting the number of subframes to the above-mentioned number.

Although in the circuit configuration shown in FIG. 4, the diode 19 is connected between source S and drain D of the lighting drive TFT 12 so as to bypass this TFT, a TFT for switching may be employed instead of this diode 19. In the case where a switching TFT is used in this manner, control is performed so that a signal by which the TFT is turned on is supplied during a period in which the reverse bias voltage is applied.

1. A drive device of an active matrix type display panel comprising a plurality of light emitting elements which are arranged at intersecting positions between a plurality of data lines and a plurality of scan lines and whose light emissions are controlled via at least lighting drive transistors, respectively, wherein a drive device of a self light emitting display panel is characterized in that
an electrode which applies an electrical potential to cathodes of the light emitting elements is electrically divided into a plurality of blocks along a scan line to be arranged,
that it is possible to select a lighting mode in which a forward voltage is applied to the light emitting elements via the lighting drive transistors and a reverse bias voltage applying mode in which a reverse bias voltage is applied to the light emitting elements, and that reverse bias voltage applying means which applies the reverse bias voltage to the light emitting elements in block units operates in the reverse bias voltage applying mode.

2. The drive device of the self light emitting display panel according to claim 1, further comprising gradation display means which time-divides a unit frame period into a plurality of subframe periods to perform lighting control and which has an erase transistor that controls extinguishing of the light emitting element during one or a plurality of subframe periods, characterized in that an extinguishing period of the light emitting elements during at least one subframe period is a length of 1/N or longer of the subframe period where the number of blocks of the divided electrode is N.

3. The drive device of the self light emitting display panel according to claim 1, characterized in that in a state in which all light emitting elements connected to either one of the blocks of the divided electrode are in the extinguishing period, the reverse bias voltage applying means applies the reverse bias voltage to all light emitting elements connected to the block.

4. The drive device of the self light emitting display panel according to claim 2, characterized in that in a state in which all light emitting elements connected to either one of the blocks of the divided electrode are in the extinguishing period, the reverse bias voltage applying means applies the reverse bias voltage to all light emitting elements connected to the block.

5. The drive device of the self light emitting display panel according to any one of claims 1 to 4, characterized by further comprising a diode or a TFT which is connected in parallel to the lighting drive transistor to become in an “on” state by the reverse bias voltage.

6. The drive device of the self light emitting display panel according to any one of claims 1 to 4, characterized in that the reverse bias voltage applying means simultaneously applies the forward voltage to all light emitting elements which are connected to either one of blocks of the divided electrode and to which the reverse bias voltage is applied, before scanning of a next subframe in the block is begun.

7. The drive device of the self light emitting display panel according to claim 5, characterized in that the reverse bias voltage applying means simultaneously applies the forward voltage to all light emitting elements which are connected to either one of blocks of the divided electrode and to which the reverse bias voltage is applied, before scanning of a next subframe in the block is begun.

8. The drive device of the self light emitting display panel according to any one of claims 1 to 4, characterized in that the light emitting elements are constituted by organic EL elements in which an organic compound is employed in a light emitting layer.

9. The drive device of the self light emitting display panel according to claim 5, characterized in that the light emitting elements are constituted by organic EL elements in which an organic compound is employed in a light emitting layer.

10. The drive device of the self light emitting display panel according to claim 6, characterized in that the light emitting elements are constituted by organic EL elements in which an organic compound is employed in a light emitting layer.

11. The drive device of the self light emitting display panel according to claim 7, characterized in that the light emitting elements are constituted by organic EL elements in which an organic compound is employed in a light emitting layer.

12. A drive method of an active matrix type display panel comprising a plurality of light emitting elements which are arranged at intersecting positions between a plurality of data lines and a plurality of scan lines and whose light emissions are controlled via at least lighting drive transistors, respectively, wherein a drive method of a self light emitting display panel is characterized in that
an electrode which applies an electrical potential to cathodes of the light emitting elements is electrically divided into a plurality of blocks along a scan line to be arranged,
that it is possible to select a lighting mode in which a forward voltage is applied to the light emitting elements via the lighting drive transistors and a reverse bias voltage applying mode in which a reverse bias voltage is applied to the light emitting elements, and that in the reverse bias voltage applying mode, the reverse bias voltage is applied to the light emitting elements in block units.

13. The drive method of the self light emitting display panel according to claim 12, characterized in that
a unit frame period is time-divided into a plurality of subframe periods so that an extinguishing period of the light emitting elements is provided during one or a plurality of subframe periods, that lighting of the respective subframe periods is controlled to perform gradation expression, and that
the extinguishing period of the light emitting elements during at least one subframe period is set to a length of 1/N or longer of the subframe period where the number of blocks divided is N.

14. The drive method of the self light emitting display panel according to claim 12, characterized in that in a state in which all light emitting elements connected to either one of blocks of the divided electrode are in the extinguishing period, the reverse bias voltage is applied to all light emitting elements connected to the block.

15. The drive method of the self light emitting display panel according to claim 13, characterized in that in a state in which all light emitting elements connected to either one of blocks of the divided electrode are in the extinguishing period, the reverse bias voltage is applied to all light emitting elements connected to the block.

16. The drive method of the self light emitting display panel according to any one of claims 12 to 15, characterized in that the forward voltage is simultaneously applied to all light emitting elements which are connected to either one of blocks of the divided electrode and to which the reverse bias voltage is applied, before scanning of a next subframe in the block is begun.
